(19) United States
(12) Patent Application Publication
(10) Pub. No.: US 2020/0370734 A1
(43) Pub. Date: Nov. 26, 2020

(54) LED GROOVE SYSTEM

(71) Applicant: LONGHORN INTELLIGENT TECH CO., LTD, Shenzhen (CN)

(72) Inventors: Haitao Yang, Shenzhen (CN); Lin Yang, Shenzhen (CN); Zhengping Huang, Shenzhen (CN); Lei Li, Shenzhen (CN)

(21) Appl. No.: 16/538,632

(22) Filed: Aug. 12, 2019

Related U.S. Application Data
(63) Continuation-in-part of application No. PCT/CN2019/087817, filed on Jun. 6, 2019.
Application No. PCT/CN2019/087817 is a continuation-in-part of application No. 16/517,352, filed on Jul. 19, 2019, now Pat. No. 10,711,986.

(30) Foreign Application Priority Data
May 21, 2019 (CN) 201920738978.6
Jun. 6, 2019 (CN) PCT/CN2019/087817

(51) Int. Cl. F21V 19/00; F21V 15/01

(52) U.S. Cl. CPC F21V 19/005; F21Y 2115/10; F21V 15/01

(57) ABSTRACT

An LED groove system has a tray having a tray sidewall; a base plate formed as a flat portion on the tray, wherein the base plate is bounded by the tray sidewall; a plurality of grooves formed on the base plate, wherein the grooves increase the rigidity of the base plate; and LED strips mounted in the plurality of grooves. The LED strips have LED chips mounted to them. The plurality of grooves includes column grooves and row grooves. The column grooves intersect the row grooves. A column groove sidewall is formed on the column groove and wherein a row groove sidewall is formed on the row groove.

### FIELD OF THE INVENTION

The present invention is in the field of LED groove mounting systems.

### DISCUSSION OF RELATED ART

A variety of different LED lighting systems have different mounting geometry for LED strips. For example, in the U.S. Pat. No. 8,523,383, Retrofitting Recessed Lighting Fixtures by inventor Valerica Grigore, published Sep. 3, 2013 the abstract discloses, “A retrofit kit assembly for a recessed lighting fixture and methods for manufacturing and installing the same are described herein. The retrofit kit includes at least two mounting brackets, which can each include at least one lamp socket. The kit also includes at least one ballast, which may be pre-wired to the sockets. Each ballast may include a temporary adhesive on a mounting side thereof, for use during the installation process. For example, the installer may provisionally mount the ballast to an interior surface of an existing housing of the fixture and then permanently mount the ballast using one or more fasteners. The mounting brackets and ballast of the kit may include captive hardware which is held in place in the aperture for the fastener prior to fastening the particular object to the recessed housing, which reduces risk of dropping or losing fasteners during installation.”

### SUMMARY OF THE INVENTION

An LED groove system has a tray having a tray sidewall; a base plate formed as a flat portion on the tray, wherein the base plate is bounded by the tray sidewall; a plurality of grooves formed on the base plate, wherein the grooves increase the rigidity of the base plate; and LED strips mounted in the plurality of grooves. The LED strips have LED chips mounted to them. The plurality of grooves includes column grooves and row grooves. The column grooves intersect the row grooves.

A column groove sidewall is formed on the column groove and wherein a row groove sidewall is formed on the row groove. Sometimes an island mesa is formed between the column groove and the row groove. The LED strips are mounted to the plurality of grooves using adhesive tape or glue. The base plate is formed as a flat portion that further comprises a grid of protrusions formed from intersections between column groove protrusions and row groove protrusions.

### BRIEF DESCRIPTION OF THE DRAWINGS

FIG. 1 is an exploded view diagram showing attachment of LED chips to the LED strip.

FIG. 2 is a LED strip with LED chips attached.

FIG. 3 is an exploded view diagram showing the LED strip being attached to the tray.

FIG. 4 is a backing plate with LED strips attached.

FIG. 5 is a top view of the tray.

The following call out list of elements can be a useful guide in referencing the elements of the drawings.
20 LED strip
21 PCB strip
22 primary PCB contact
23 secondary contact
24 tertiary PCB contact
25 LED chip
26 first chip contact
27 second chip contact
28 third chip contact
29 chip edge
31 first tip
32 second tip
33 left edge
34 right edge
35 glue holder
36 glue
37 adhesive strip
38 tray border edge
39 tray sidewall
40 tray
41 base tray
42 row groove
43 column groove
44 row groove sidewall
45 column groove sidewall
46 column groove protrusion
47 row groove protrusion
48 grid of protrusions
50 island
51 first island column wall
52 second island column wall
53 first island row sidewall
54 second island row sidewall
55 island mesa
56 first swivel hook
57 second swivel hook
58 tray border
59 border protruding rib

### DETAILED DESCRIPTION OF THE PREFERRED EMBODIMENT

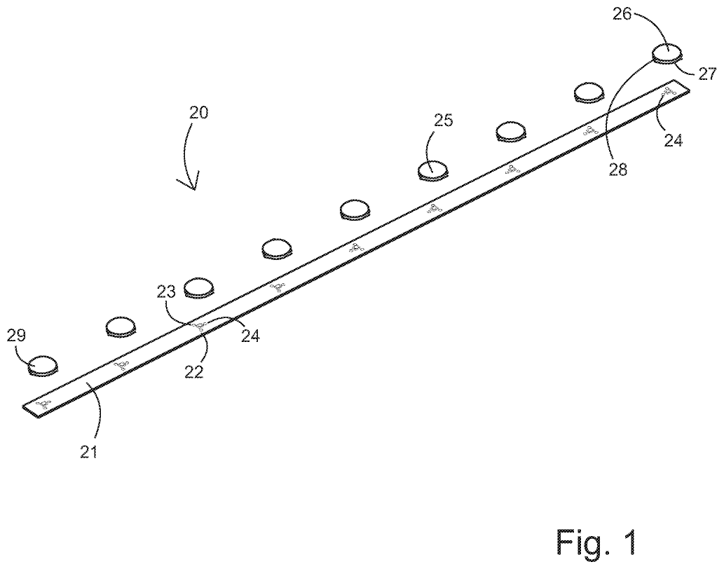

As seen in FIG. 1, an LED strip 20 includes a PCB strip 21. LED chips 25 mount to the PCB strip 21. The PCB strip 21 has a circuit connecting the LED chips 25 in series or parallel, or in a combination of series and parallel. Each LED chip 25 includes a first chip contact 26, a second chip contact 27 and a third chip contact 28. The PCB strip 21 includes a primary PCB contact 22, a secondary PCB contact 23, and a tertiary PCB contact 24 connected to the circuit trace on the PCB strip 21. The first chip contact 26 contacts the primary PCB contact 22. The second chip contact 27 contacts the secondary PCB contact 23, and the third chip contact 28 contacts the tertiary PCB contact 24. Preferably, the contacts of the LED chip 25 are machine soldered to the contacts of the PCB strip 21. The PCB chips are arranged linearly on the linearly shaped PCB strip 21. Each of the LED chips 25 have a chip edge 29 and the LED chip contacts can be formed at least partially on the chip edge 29.

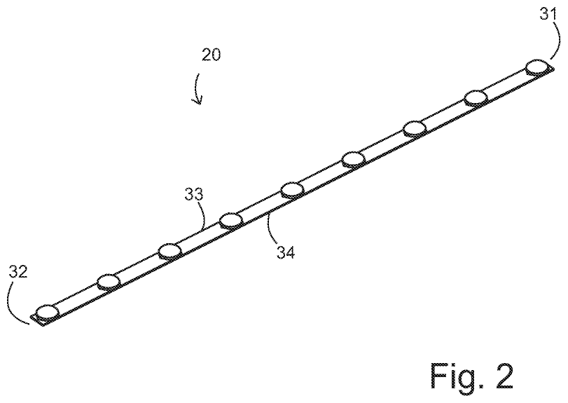

As seen in FIG. 2, each LED strip 20 further includes a left edge 33 and a right edge 34. The left edge 33 and the right edge 34 are elongated and terminate at the first tip 31 and a second tip 32.

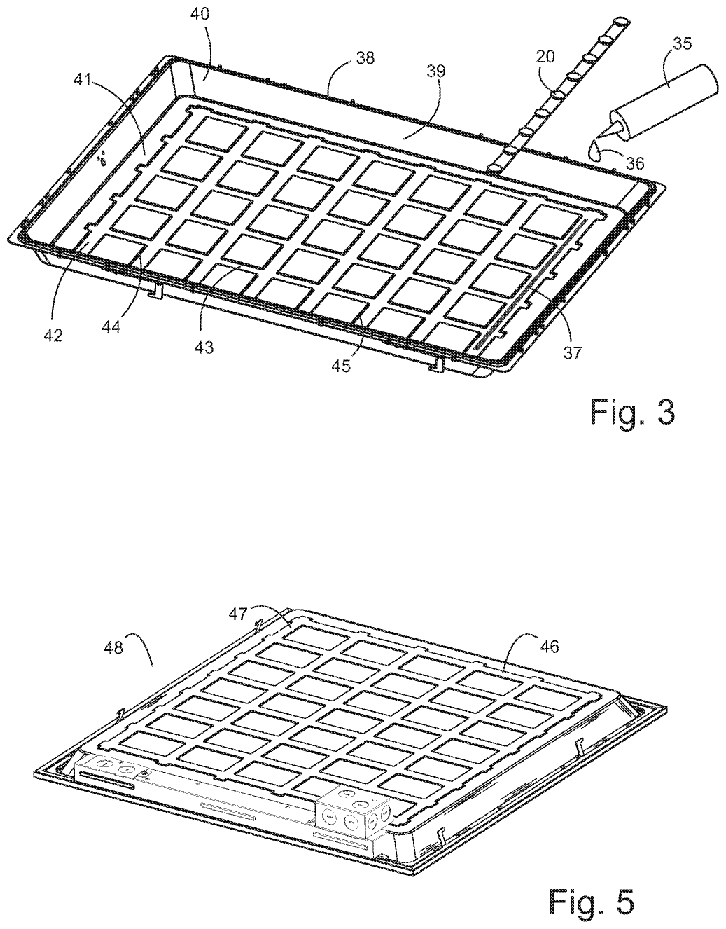

As seen in FIG. 3, each LED strip 20 can be mounted in a tray 40. The tray 40 is a reflector having a reflective surface. The tray 40 preferably has a tray sidewall 39 with a tray border edge 38. The tray sidewall 39 is reflective and directs light emitted from the LED strip 20. The tray sidewall 39 has four sides and one of the sides of the tray sidewall 39 is configured to be parallel to the LED strip 20. The LED strip 20 fits in a row groove 42, or a column groove 43 of the tray 40. The tray 40 can be formed as a sheet of plastic or metal with an array of grooves formed on a base plate 41. The base plate 41 has grooves that give structure to the tray 40 and increase the rigidity of the tray 40, especially at the base plate 41 of the tray. Optionally, the grooves could continue to the tray sidewall 39 for additional rigidity. The column groove sidewall 45 is formed on the column groove 43. The row groove sidewall 44 is formed on the row groove 42.

An adhesive strip 37 or glue 36 dispensed from a glue holder 35 can adhere the lower surface of the LED strip 20 to the tray 40. The adhesive can contain thermal grease or a thermal transfer gel that accelerates thermal transfer from the LED strip 20 to the tray 40. The LED strip 20 is lodged in the row groove or the column groove and adds structure to the base plate 41 in addition to the structure added by the row groove 42 or the column groove 43.

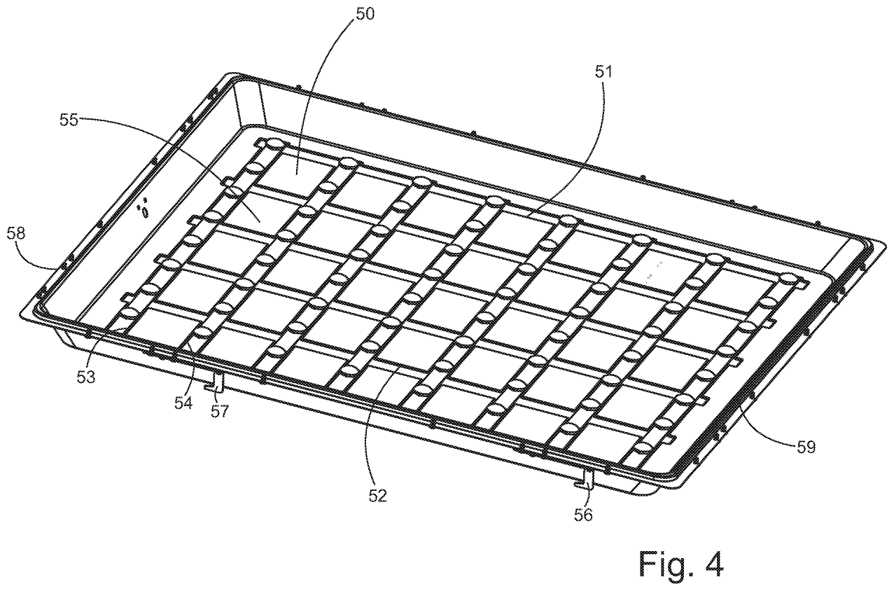

As seen in FIG. 4, the row grooves 42 are perpendicular to the column grooves 43 and interconnect so that square or other polygon shaped islands 50 are formed on the base plate 41. Each of the islands 50 have a protruding island mesa 55 which is a flat area raised away from the grooves. The islands are arranged in rows and have a first island row sidewall 53 and a second island row sidewall 54 that engage to and retain a left edge 33 and right edge 34 of the LED strip 20. Similarly, the islands also have a first island column wall 51 and a second island column wall 52 that can engage and retain a left edge 33 and right edge 34 of the LED strip 20.

Additionally, the tray sidewall 39 may extend outwardly to a tray border 58. The first swivel hook 56 and a second swivel hook 57 can be mounted to one edge of the tray border 58. The tray border may further include a border protruding rib 59 formed as a flat extension extending away from the mesa islands. The first swivel hook 56 and the second swivel hook 57 are configured to engage a light fixture. Additionally, a lens can be placed over the tray 40.

As seen in FIG. 5, column groove protrusions 46 protrude from the formation of column grooves 43 and row groove protrusions 47 protrude from the formation of row grooves 42. The column groove protrusions 46 and the row groove protrusions 47 intersect to form a grid of protrusions on the base plate 41. The grid of protrusions 48 on the base plate 41 increases the rigidity of the base plate 41. The base plate 41 is formed of a flat sheet of material such as plastic or metal and when embossed with the grid of protrusions 48 becomes more rigid.

1. An LED groove system comprising:
a. a tray having a tray sidewall, wherein the tray is a reflector having a reflective surface;
b. a base plate formed as a flat portion on the tray, wherein the base plate is bounded by the tray sidewall;
c. a plurality of grooves formed on the base plate; and
d. LED strips mounted in the plurality of grooves, wherein the LED strips have LED chips mounted to them, wherein each LED strip further includes a left edge and a right edge, wherein the left edge and the right edge are elongated and terminate at a first tip and a second tip, wherein the plurality of grooves includes column grooves and row grooves, wherein the column grooves intersect the row grooves, wherein the LED strips fit within a row groove, or a column groove of the tray, wherein a column groove sidewall is formed on the column groove and wherein a row groove sidewall is formed on the row groove, wherein the LED strips are mounted onto the reflective surface.

2. (canceled)

3. (canceled)

4. The LED groove system of claim 2, further including an island mesa formed between the column groove and the row groove.

5. The LED groove system of claim 1, wherein the LED strips are mounted to the plurality of grooves using adhesive tape.

6. The LED groove system of claim 1, wherein the LED strips are mounted to the plurality of grooves using glue.

7. The LED groove system of claim 1, wherein the base plate is formed as a flat portion that further comprises a grid of protrusions formed from intersections between column groove protrusions and row groove protrusions.

8. (canceled)

9. (canceled)

10. The LED groove system of claim 8, further including an island mesa formed between the column groove and the row groove.

11. The LED groove system of claim 7, wherein the LED strips are mounted to the plurality of grooves using adhesive tape.

12. The LED groove system of claim 7, wherein the LED strips are mounted to the plurality of grooves using glue.

13. The LED groove system of claim 7, wherein the right edge and the left edge align to the column groove sidewall or the row groove sidewall when the LED strips fit within a row groove, or a column groove of the tray.
